(19) United States
(12) Patent Application Publication
(10) Pub. No.: US 2001/0030374 A1
(43) Pub. Date: Oct. 18, 2001

(54) Gas-liquid contacting tray

(76) Inventors: Bernardinus Henricus Bosmans, Amsterdam (NL); Wilhelmus Adrianus Theodorus Uijen, Amsterdam (NL)

Correspondence Address: Shell Oil Company, Legal-Intellectual Property, P.O. Box 2463, Houston, TX, 77252-2463, US

(21) Appl. No.: 09/757,887

(22) Filed: Jan. 10, 2001

(30) Foreign Application Priority Data
Feb. 16, 2000 (EP) 00200521.3

(51) Int. Cl. B01F 3/04

(52) U.S. Cl. 261/114.1; 261/114.2; 261/114.3; 261/114.4

(57) ABSTRACT

The invention relates to a gas-liquid contacting tray provided with a bubble area, a liquid discharge area and an overflow weir along the boundary of the bubble area and the liquid discharge area, on which tray, when in use, a liquid flow in the direction of the liquid discharge area is present just above the surface of the bubbling area, in which the overflow weir is formed such that it guides the liquid flow in a backwards direction.

### FIELD OF THE INVENTION

The invention relates to a gas-liquid contacting tray provided with a bubble area, a liquid discharge area and an overflow weir along the boundary of the bubble area and the liquid discharge area, on which tray, when in use, a liquid flow in the direction of the liquid discharge area is present just above the surface of the bubbling area. Such trays can be used in an apparatus for counter-currently contacting gas and liquid. An exemplary use of these trays is as distillation column internals.

### BACKGROUND OF THE INVENTION

On increasing the liquid and/or gas load in an apparatus for counter-currently contacting gas and liquid, a maximum load, i.e. a maximum capacity, will be observed. Higher loads will result in that the apparatus fails to function as a gas-liquid contactor due to a phenomena known as flooding. Flooding is described as excessive accumulation of liquid inside the column. The well known flooding mechanisms are downcomer back-up, jet flooding and downcomer choking. These mechanisms are for example described in “Distillation design” by Henry Z. Kister, 1992, McGraw-Hill Inc., chapter 6, pages 271 to 273. The present invention relates to the problem of downcomer choking.

Downcomer choking is caused by an excessive aerated liquid velocity in the downcomer. At a certain velocity the friction losses in the downcomer and downcomer entrance become excessive, and a liquid or a frothy mixture, present on a tray, can not be transported to the tray below, causing liquid accumulation on the tray. The term froth means any gas-liquid mixture present on the tray not depending on any flow regime. Furthermore the term gas is to be understood as also including vapours.

The object of the present invention is to provide a tray which, when used in an apparatus for countercurrently contacting gas and liquid, increases the capacity by reducing the flooding tendency due to downcomer choking.

### SUMMARY OF THE INVENTION

The object of the invention has been achieved by using the following gas-liquid contacting tray: a gas-liquid contacting tray provided with a bubble area, a liquid discharge area and an overflow weir along the boundary of the bubble area and the liquid discharge area, on which tray, when in use, a liquid flow in the direction of the liquid discharge area is present just above the surface of the bubbling area, wherein the overflow weir is formed such that it guides the liquid flow in a backwards direction.

### BRIEF DESCRIPTION OF THE FIGURES

The figures can shortly be described as follows:

FIG. 1 shows a horizontal cross sectional view along line A-A′ of FIG. 2 of a column provided with a plurality of axially spaced trays according to the invention.

FIG. 2 shows a vertical cross sectional view along line B-B′ of FIG. 1 of a column provided with several different preferred embodiments of trays according to the invention.

### DETAILED DESCRIPTION OF THE INVENTION

It has been found that the tray of the invention, when used in an apparatus for counter-currently contacting gas and liquid, reduces the flooding tendency due to downcomer choking, and increases the capacity as compared to when a tray of the state of the art is used.

It is known to position the overflow weir vertically. In some cases, however, it has been found practical to prepare the overflow weir and the downcomer wall from one piece of plate. In the case that the downcomer wall is sloped, the overflow weir will then be sloped as well. The reason to slope downcomers is to minimise the liquid receiving area on the tray just below, thereby increasing the bubble area on a tray. This slope is, however, not less than 80° relative to the plane of the horizontal tray. Applicants have now found that by further sloping the overflow weir, a decrease in downcomer choking and an increase in capacity can be obtained.

An apparatus for counter-currently contacting gas and liquid, for example a vertical positioned column, can be provided with a plurality of vertically spaced gas-liquid contacting trays according to the invention, having a bubble area and a liquid discharge area. In such an apparatus, liquid will be supplied to such a tray from the liquid discharge area of the tray just above, if present. The liquid will fall directly onto the bubble area or onto a liquid receiving area, optionally present, from where it will flow over the bubble area to the liquid discharge area. In the bubble area the liquid will be contacted with upwardly moving gas, flowing through openings in the tray. A strong flow of the liquid just above the surface of the bubbling area in the direction of the liquid discharge area is observed. While not wishing to be bound to any theory, applicants believe that by redirecting this flow of liquid just above the bubble area, before entering the liquid discharge area, in a backwards direction, the capacity increase is achieved.

The overflow weir is formed such that it guides the above mentioned flow of liquid in a backwards direction at the weir. Preferably the overflow weir is positioned on the boundary of the bubble area and the liquid discharge area. The liquid just above the surface of the bubbling area is understood to be the layer of liquid positioned on top of the surface of the tray and having a thickness equal to the height of the overflow weir. The backwards direction is understood to be the direction of the flow at the weir, containing a horizontal and a vertical vector component, whereby the horizontal vector component is directed contrary to the average direction of the liquid flow over the bubble area to the liquid discharge area. In guiding the liquid flow in a backwards direction it will not directly fall into the downcomer opening. The backwards direction can be brought about by any shape of the overflow weir, known to one skilled in the art to be able to perform such a function. Preferably the overflow weir is inclined towards the bubble area, i.e. the upper part of the overflow weir leans away from the vertical in the direction contrary to the average direction of the liquid flow. Preferably the overflow weir is inclined such that an imaginary line, drawn from the top of the overflow weir to the base of the overflow weir, forms an angle α with the horizontal plane of the tray which is between 30° and 80°, more preferably between 40° and 70°, and most preferably between 40° and 50°. The invention therefore includes a gas-liquid contacting tray provided with a bubble area, a liquid discharge area and an overflow weir along the boundary of the bubble area and the liquid discharge area, wherein the overflow weir is inclined towards the bubble area, such that an imaginary line, drawn from the top of the overflow weir to the base of the overflow weir, forms an angle α with the horizontal plane of the tray as described above. Suitable shapes for the overflow weir include those wherein the overflow weir is sloped, hooked or curved.

The height of the overflow weir and the width of the overflow weir, can be optimised by one skilled in the art, such that the height (h) and width (w) are sufficient to enable the overflow weir to perform its function of guiding the flow in a backwards direction and such that the height (h) is sufficient to maintain the desired liquid height on the tray and that the width (w) is not interfering with the bubble area in a capacity reducing manner. Preferably overflow weir heights lie in the range from 25 mm to ⅙ of the height of the tray spacing. Tray spacing is the spacing between two consecutive contacting trays. Suitably the tray spacing is between 0.2-1 m.

The bubble area of the tray may be any bubble area known to one skilled in the art. In the bubble area the tray is provided with openings for the passage of gas. Examples of suitable openings include bubble-cap openings, sieve tray openings, valve tray openings and fixed valve tray openings. The shape of these openings may be any shape generally known to one skilled in the art, including circular, triangular, rectangular and slit-like shapes. Examples of these openings can be found in general text books such as the above mentioned general textbook of Kister on pages 260 to 267, and in patent publications U.S. Pat. No. 5,120,474, U.S. Pat. No. RE 27,908, WO-A-9828056, WO-A-9737741, U.S. Pat. No. 5,911,922, U.S. Pat. No. 3,463,464 and U.S. Pat. No. 5,454,989.

The liquid discharge area of the tray may be any liquid discharge area known to one skilled in the art and could have any suitable shape, for example a circular, rectangular, segmental or square shape. The liquid discharge area may comprise one or more downcomer passages. The area of the upper opening of the downcomer passage, i.e. the downcomer opening, can be part of, or is the same as the liquid discharge area. Suitable shapes for the downcomer opening include circular, rectangular, segmental and square shapes. Suitable downcomers include conventional downcomers and truncated downcomers. The wall(s) of the downcomer can be vertical, or sloped from the vertical, i.e. making an angle smaller than 90° relative to the horizontal tray. Examples of suitable downcomers can be found for example in patent publications U.S. Pat. No. 5,244,604, GB-A-1416731, GB-A-1416732, GB-A-1422132, GB-A-1422131, EP-A-0155056, U.S. Pat. No. 5,223,183, DE-A-2140899, EP-A-882481 and WO-A-9851390. Preferably rectangular downcomers are used, because the advantages of the invention are especially achieved for such an embodiment.

The tray layout of bubble area and liquid discharge area may be any layout known to one skilled in the art. The gas-liquid contacting tray may contain one or more bubble areas, overflow weirs or liquid discharge areas. Suitable tray layouts include trays with a reverse flow, one-pass trays and multi-pass trays, for example double-pass or four-pass trays. The invention can be advantageously applied with the trays described in patent publications no's EP-A-0734748, U.S. Pat. No. 5,242,628, U.S. Pat. No. 5,098,615, U.S. Pat. No. 5,382,390, U.S. Pat. No. 3,410,540, U.S. Pat. No. 4,956,127, U.S. Pat. No. 5,453,222, U.S. Pat. No. 4,550,000, WO-A-9626779, WO-A-9525571, BE-B-584426 and DE-A-2305564.

A preferred tray-layout is a tray that is divided along a diametrical line in two tray sections, each tray section being provided with a bubble area and with a plurality of parallel rectangular downcomers open at the upper end and closed at the bottom end, which bottom end is provided with a plurality of liquid discharge openings and which downcomers extend horizontally and perpendicular from the diametrical line to the circumferential of the tray. The downcomers in one section are arranged such that they meet the diametrical line in an alternating fashion relative to the downcomers in the opposite tray section.

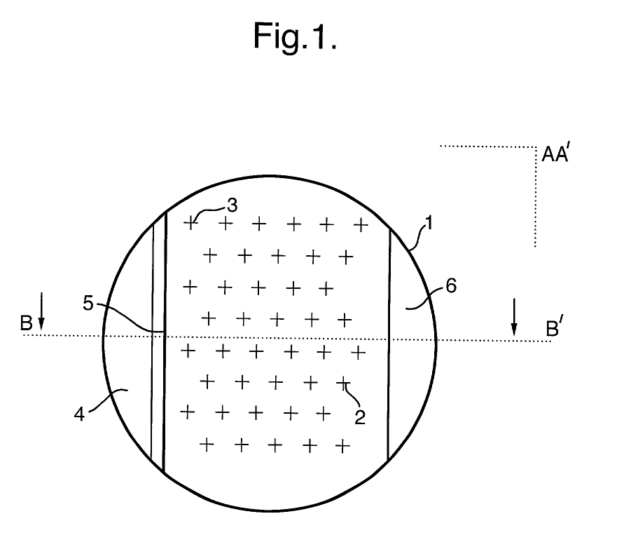

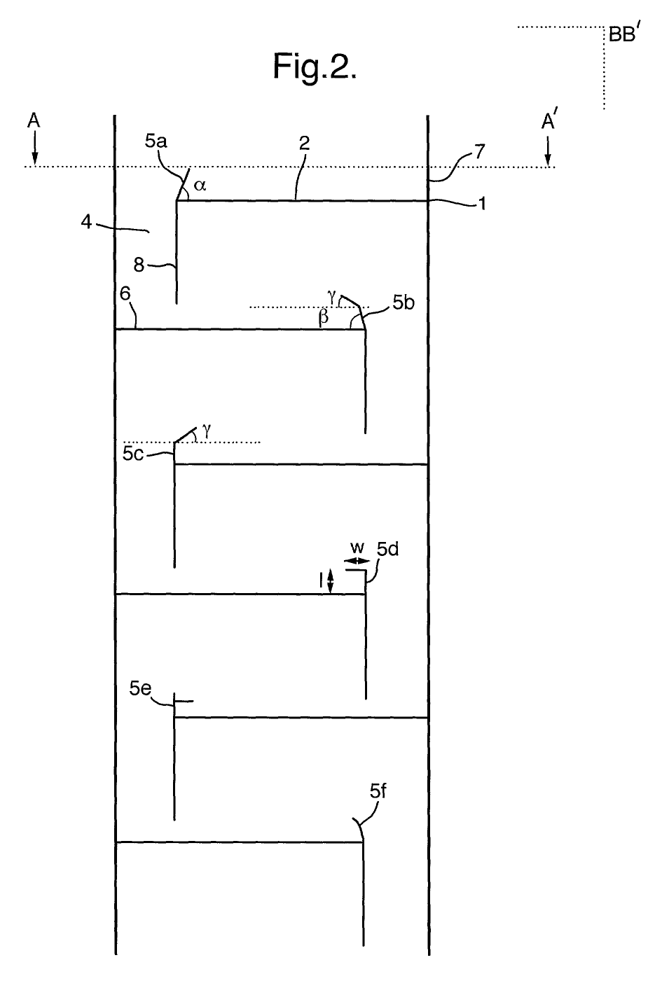

The invention will be illustrated by making use of FIGS. 1 and 2. The invention is, however, in no way limited to these figures.

Referring now to the figures, FIG. 1 shows a top view of a gas-liquid contacting tray 1, provided with a bubble area 2, provided with openings 3 through which gas can rise, and a liquid discharge area 4. In this case the liquid discharge area 4 and the downcomer opening are the same. On the boundary of the bubble area 2 and the liquid discharge area 4 an overflow weir 5 is present. When in use, the liquid is supplied to the tray through the liquid discharge area of a tray just above and falls onto a liquid receiving area 6, which is placed below the liquid discharge area of the tray just above.

The column 7 shown in FIG. 2, illustrates six different gas-liquid contacting trays 1, each provided with the same features as the gas-liquid contacting tray 1 in FIG. 1 and in addition with a downcomer wall 8 and each illustrating a possible preferred design of the overflow weir 5. It will be understood that for practical purposes a column 7 will be provided with trays having all the same design. The overflow weir is sloped 5a, hooked 5b, 5c, 5d and 5e or curved 5f in the direction of the bubble area 2.

In a preferred embodiment the overflow weir is sloped 5a. It is preferably sloped in such a way that a line from top of the overflow weir 5a to the bottom of the overflow weir 5a makes an angle a with the plane of the horizontal tray 1. This angle α is the same as the angle α mentioned hereinbefore for the imaginary line, drawn from the top of the overflow weir 5 to the base of the overflow weir 5. The overflow weir 5a is formed along this imaginary line and the overflow weir makes preferred angles with the horizontal plane as described hereinbefore for the imaginary line.

In a further preferred embodiment the overflow weir 5b is hooked, having an upper part which is more sloped than the bottom part. The bottom part of such a hooked overflow weir 5b is preferably sloped in such a way that a line from top of the bottom part, i.e. the hook, to the bottom of the overflow weir 5b makes an angle β between 30° and 90°, more preferably between 50° and 90° with the plane of the horizontal tray 1. The upper part of such a hooked overflow weir 5b is preferably sloped in such a way that a line from top of the upper part of the overflow weir 5b to the hook makes an angle γ between 0° to 70°, more preferably between 0° and 50° with the plane of the horizontal tray 1.

In a next preferred embodiment the overflow weir 5c is hooked in such a way that the bottom part of the overflow weir 5c makes an angle β of 90° with the plane of the horizontal tray 1 and the upper part makes an angle γ of from 0° to 50° with the plane of the horizontal tray. Preferably a bottom part, making an angle β of 90° with the plane of the horizontal tray is combined with an upper part, where the upper part of the overflow weir 5d makes an angle of 0° with the plane of the horizontal tray 1, in other words, the overflow weir is right angled 5d. The hooked overflow weir may in addition have a straight or sloped (not shown) extension on it 5e.

In a final preferred embodiment the overflow weir is curved 5f, in such a way that the curvature enables the overflow weir 5f to perform its function of guiding a liquid flow in a backwards direction. The overflow weir may be wholly curved or a curved part may be put on top of a vertical part (not shown).

Overflow weir(s), downcomer wall(s) and downcomer bottom are preferably made from one metal plate. Preferably the plate is first provided with liquid discharge openings in the downcomer bottom part by for example punching, cutting or drilling. By bending the plate along a number of longitudinal lines the plate is transformed into overflow weir(s), downcomer wall(s) and downcomer bottom. For example an essentially rectangular downcomer, as described in GB-A-1422131, can be manufactured by first providing the plate with liquid discharge openings for the downcomer bottom and next bending the plate along four longitudinal lines, i.e. along the boundaries of downcomer wall and overflow weir and along the boundaries of downcomer wall and downcomer bottom. By adding two more downcomer walls at both smaller ends, a so-called boxed downcomer is obtained. A downcomer having a sloped, curved or hooked weir as described above can be simply made according to the above-described method.

Existing trays may advantageously be retrofitted by altering or adding a weir in such a way that a tray according to the invention is obtained. By this alteration a capacity increase can be simply attained.

The invention further relates to an apparatus for counter-currently contacting gas and liquid comprising a plurality of gas-liquid contacting trays as described hereinabove, vertically spaced from each other. Such an apparatus can be used for (reactive) distillation, absorption or heat exchange. Preferably the apparatus is used for the distillation of hydrocarbons.

We claim:

1. A gas-liquid contacting tray comprising:
a liquid discharge area;
a bubble area connected to the liquid discharge area; and,
an overflow weir along a boundary of the bubble area and the liquid discharge area formed such that it guides liquid flow in a backwards direction.

2. The gas-liquid contacting tray of claim 1, in which the overflow weir is inclined towards the bubble area.

3. The gas-liquid contacting tray of claim 1, in which the overflow weir is inclined towards the bubble area at an angle, α, which is smaller than approximately 80°.

4. The gas-liquid contacting tray of claim 3, in which the overflow weir has a height of approximately 25 mm.

5. The gas-liquid contacting tray of claim 1, in which the overflow weir comprises a sloped, hooked or curved shape.

6. The gas-liquid contacting tray of claim 3, in which the overflow weir is inclined toward the bubble area at an angle between approximately 30° and approximately 80°.

7. The gas-liquid contacting tray of claim 3, in which the overflow weir comprises a hooked shape.

8. The gas-liquid contacting tray according to claim 7, in which the overflow weir forms a right angle.

9. The gas-liquid contacting tray of claims 1, in which the downcomer is rectangular.

11. An apparatus for counter-currently contacting gas and liquid comprising a plurality of the gas-liquid contacting trays of claim 1 vertically spaced from each other.
